(19) United States
(12) Patent Application Publication
(10) Pub. No.: US 2013/0227113 A1
(43) Pub. Date: Aug. 29, 2013

(54) MANAGING VIRTUALIZED NETWORKS BASED ON NODE RELATIONSHIPS

(71) Applicants: Dorit Baras, Haifa (IL); Akram Bitar, Kfar Peqiin (IL); Benny Rochwerger, Zichron Yaakov (IL); Amir Ronen, Haifa (IL)

(72) Inventors: Dorit Baras, Haifa (IL); Akram Bitar, Kfar Peqiin (IL); Benny Rochwerger, Zichron Yaakov (IL); Amir Ronen, Haifa (IL)

(73) Assignee: International Business Machines Corporation, Armonk, NY (US)

(21) Appl. No.: 13/405,305

(22) Filed: Feb. 26, 2012

(51) Int. Cl. G06F 15/16

(52) U.S. Cl. 709/224

(57) ABSTRACT

Systems and methods for optimizing a virtualized communication network are provided. The method comprises monitoring traffic among nodes in a virtualized communication network to determine one or more relationships among the nodes, wherein the nodes include physical and logically defined components; determining whether one or more edges connecting the nodes in the communications network satisfy a rule; grouping the nodes connected by the one or more edges that satisfy the rule into at least one group; ranking the nodes in the group in accordance with a parameter; and implementing a policy to optimize the virtualized communication network in accordance with information determined from the ranking or the grouping of the nodes.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to network management in a computing environment and, more particularly, to a system and method for managing virtualized computing networks based on identifiable characteristics and relationships among the nodes in the network.

### BACKGROUND

Managing communications networks that support virtualized resources can be a challenging endeavor depending on the number of physical and virtualized nodes in the network. Sophisticated management schemes may be needed to define the appropriate relationships or update the assigned responsibilities among several physical and virtualized nodes as the network grows or the related system requirements evolve.

In such complex networks, generally, a coherent management policy is required for many types of tasks such as migration, software/hardware updates, disaster recovery, resource allocation, etc. Current management approaches depend on a variety of factors to control the above-noted tasks. For example, traffic among the various communication paths in the network may be analyzed to determine whether a system resource in a high traffic area needs to be updated, modified or enhanced to increase efficiency.

Due to the fact that resources in a network that has virtualized components may be either physically or logically defined, the analysis tools used for gathering information about the various system components need to take into account such differences, and as such require prior knowledge of the nature of the nodes involved. Furthermore, said analysis often requires active monitoring of the relationship among system components, which is time consuming and resource intensive.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, a method for optimizing a virtualized communication network is provided. The method comprises monitoring traffic among nodes in a virtualized communication network to determine one or more relationships among the nodes, wherein the nodes include physical and logically defined components; determining whether one or more edges connecting the nodes in the communications network satisfy a rule; grouping the nodes connected by the one or more edges that satisfy the rule into at least one group; ranking the nodes in the group in accordance with a parameter; and implementing a policy to optimize the virtualized communication network in accordance with information determined from the ranking or the grouping of the nodes.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an exemplary virtualized computing environment in accordance with one or more embodiments, wherein a plurality of virtualized nodes are hosted by one or more physical machines in a communications network.

FIG. 2 is an exemplary flow diagram of a method of implementing management policy in a virtualized network, in accordance with one embodiment.

FIGS. 3A and 3B are block diagrams of hardware and software environments in which the disclosed systems and methods may operate, in accordance with one or more embodiments.

FIG. 4A depicts a cloud computing node according to one embodiment.

FIG. 4B depicts a cloud computing environment according to one embodiment.

FIG. 4C depicts abstraction model layers according to one embodiment.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

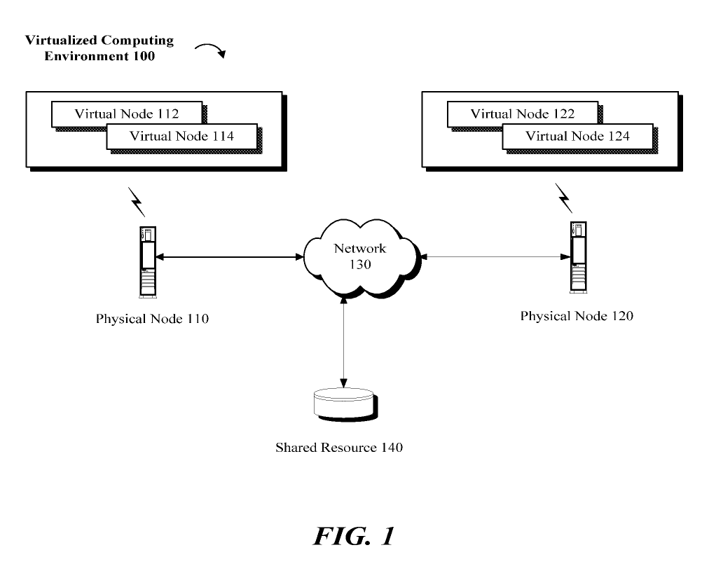

Referring to FIG. 1, an exemplary virtualized computing environment 100 is illustrated, in accordance with one embodiment. As shown, physical nodes 110 and 120 are connected by way of network 130 to each other and other nodes and optionally to one or more shared resource(s) 140. A physical node may host one or more virtual nodes. A physical node may be a computer system or computing machine that provides the underlying infrastructure for the execution and operation of the virtual nodes.

For example, as shown, physical node 110 hosts virtual nodes 112 and 114, while physical node 120 hosts virtual nodes 122 and 124. Depending on implementation, a virtual node may communicate with other physical nodes or virtual nodes hosted over the same or another physical node, as well as shared resources over network 130. Communication among nodes results in data traffic being generated over the network. As an example, virtual node 112 may communicate with virtual nodes, 114, 122, 124 and shared resource(s) 140 via one or more communication routes.

For efficiency and optimization, it would be desirable to reduce or limit the amount of traffic generated over the network. By way of a simple non-limiting example, consider a scenario in which virtual node 112, running on physical node 110, routinely submits requests that are to be serviced by physical node 120. Since virtual node 112 requests are submitted to the remotely situated physical node 120 over network 130, to reduce network traffic, it may be desirable to migrate virtual node 112 to be hosted on physical node 120, depending on the costs associated with and the savings achieved due to said migration.

To achieve such network efficiencies, relationships among physical and virtual nodes in network 130 may be analyzed based on a variety of factors such as, for example, (a) the level of traffic between a first node and a second node, (b) the number of neighbor nodes that the first node and the second node have in common (e.g., this can be based on the direction of traffic incoming or outgoing), (c) aggregated amount of traffic to a node, (d) the distance between a first node and a second node (i.e., the number of neighboring nodes in between that connect the two nodes), etc.

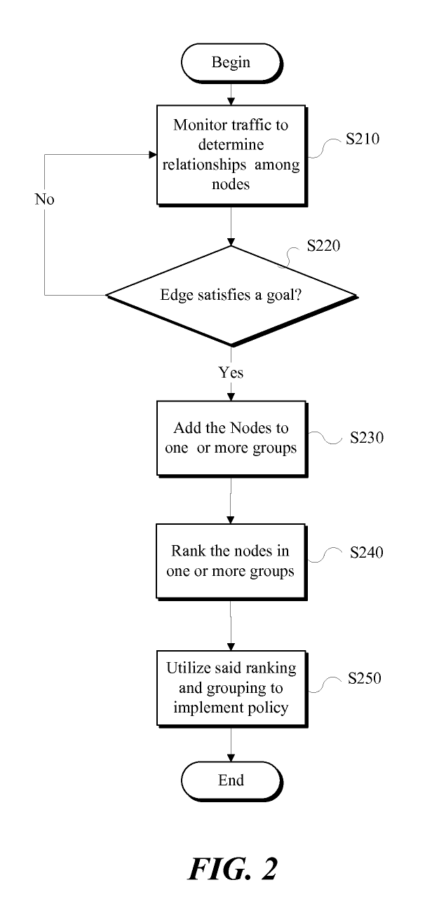

Accordingly, referring to FIG. 2, in one embodiment traffic among the nodes in network 130 is monitored to help determine the relationships or the strength of relationships among the nodes (S210). In one example implementation, a matrix may be constructed in which the nodes are connected together by edges, where an edge between two nodes indicates the existence of a relationship between the two nodes, such that a heavier weight assigned to an edge would indicate a stronger relationship.

In the example scenario mentioned above with reference to FIG. 1, virtual nodes 112, 114, 122, 124 and physical nodes 110, 120 and shared resource 140, would be designated as the nodes in network 130, for example. The monitoring of the traffic among said nodes may indicate that virtual node 112 submits requests to physical node 120, for example, X number of times per hour, and that virtual node 114 submits requests to physical node 120, Y number of times per hour, for example.

In the above example, a first directional edge (e.g., vector) may be established from virtual node 112 to physical node 120, and a second directional edge may be established from virtual node 114 to physical node 120. If X is greater than Y, then the weight assigned to the first edge would be heavier than the weight assigned to the second edge, indicating a stronger relationship between virtual node 112 and physical node 120 than the relationship between virtual node 114 and physical node 120, for example.

Using the above-noted or similar implementation, it is possible to identify and group a plurality of nodes into one or more groups or clusters, if it is determined that one or more edges connecting the nodes satisfy a certain relationship-based goal (e.g., a definable rule) (S220, S230). A relationship-based goal may be defined by a rule that defines one or more limitations and parameters for grouping one or more sets of nodes together. For example, it may be desirable to group two nodes that are connected by an edge, satisfying the following rule: w1*traffic+w2*amount of shared incoming entities+w3*amount of shared outgoing entities>T1, wherein T1 is a defined threshold and w1, w2, w3 are assigned weights to network or node characteristics that are of certain importance in determining network management policies.

Accordingly, edges that satisfy one or more rules may be identified (e.g., by way of a constraint satisfaction problem or otherwise) to allow for grouping of two or more nodes. It is noteworthy that in the above implementation, characteristics of the edges, as opposed to those of the nodes, may be easily monitored. Where applicable, the edges that define certain target relationships among the nodes are maintained and the edges that do not are removed from consideration. In this manner, the analysis may be focused on more important relationships without the less important ones cluttering the process, providing a dynamically reducible problem.

Once the nodes are grouped, the nodes in a group may be ranked (S240). The ranking of the nodes may be accomplished by way of applying an algorithm to the nodes based on a variety of attributes or corresponding features (e.g., node popularity, connectivity, activity level, etc.). In one embodiment, the raking algorithm may be implemented similar to a page-ranking algorithm used for ranking web-pages on the Internet, for example. The above grouping and ranking may be then utilized to implement a policy to manage the nodes in the network based on the understanding of a meaningful relationship among the nodes in the selected group.

Referring back to the example of FIG. 1, it may be desirable to optimize the assignments of virtual machines (i.e., virtual nodes) to the physical hosts (i.e., physical nodes). According to the example method in FIG. 2, the virtual nodes may be grouped into clusters that are strongly connected to each other (e.g., via direct traffic and shared neighbors). Then each cluster may be analyzed to determine if the virtual nodes are assigned to the physical nodes that service their requests.

Remember that in the earlier example, physical node 120 serviced virtual node 112 requests, and physical node 110 serviced virtual node 122 requests. Depending on the weights (e.g., X and Y) assigned to the edges that define the relationships between the nodes, it may be determined that virtual node 112 is to be migrated to physical node 120. As such, virtual node 112 may be added to the target group that includes the nodes to be migrated to physical node 120. However, the relationship between another node (e.g., virtual node 114) and physical node 120 may not be strong enough to suggest a migration for that scenario. Therefore, virtual node 114 would not be added to the target group.

The provided grouping method may be utilized in a variety of applications. As another example, consider a scenario in which it is desirable to update software that it running on a plurality of nodes in a network. For efficiency, it may be desirable to spread the update by way of nodes that have the most connectivity (i.e., the most popular nodes), instead of pushing the update to all the nodes in the network from a single source. In an example implementation, the popular nodes frequently transfer packets to other nodes as a part of the routine network traffic, and are utilized to also transfer the updates in increments in each packet transfer.

In the above example, a rule may be defined that identifies the popular nodes in the network by way of an algorithm that determines the nodes with, for example, the highest number of relationships with other nodes, and the average distance among said nodes. Nodes with a high number of connections and shorter distances to the neighboring nodes may be grouped and identified as the popular nodes and utilized to virally spread a software update over the nodes in the network.

Depending on implementation, the relationship among the nodes in the network may be defined by way of a matrix constructed based on log files. The construction would take into account the packet/operation transfer between the nodes and the data would be analyzed for two purposes: one to determine the structure of a logical network for the nodes, and second to determine direction and strength of connection between the nodes. Algorithms that define an applicable analysis strategy may be then applied to the matrix to group the nodes and rank them by importance within groups. As such, various statistics on each group may be compiled to help define policies for network management and optimization.

Using the above matrix, advantageously, high order interactions may be identified by analysis of log files without requiring advance or detailed knowledge of node attributes or their relationships. Said matrix may be generated and is suitable for virtualized computing environments in which data packets or storage blocks may define interactions and be applied to both virtual and physical nodes as long as the relevant data log exists. The analysis may be also fine-tuned to balance precision over computational complexity by adjusting the corresponding parameters.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

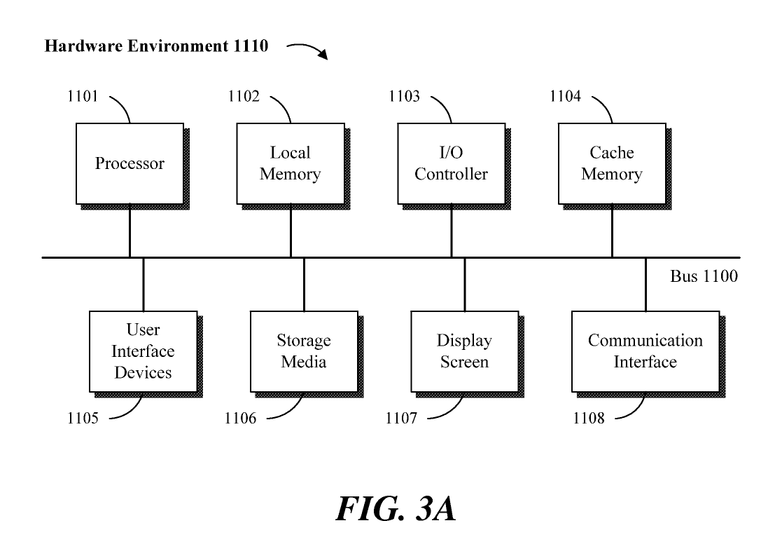

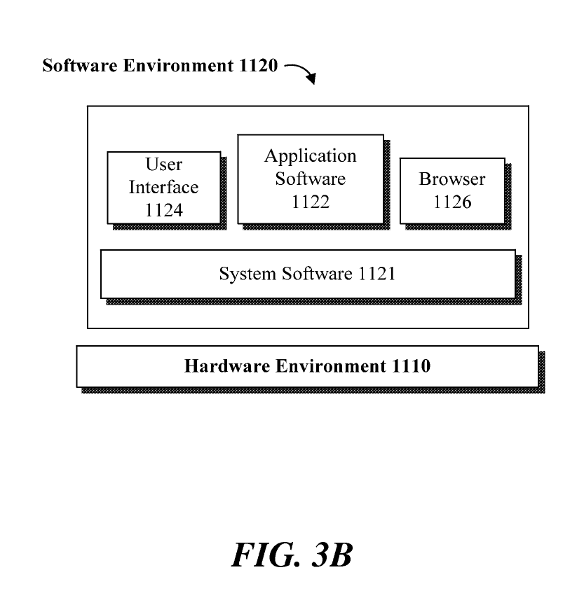

Referring to FIGS. 3A and 3B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 3A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 3B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

Cloud computing is a model of service delivery for enabling convenient, on-demand network access to a shared pool of configurable computing resources (e.g. networks, network bandwidth, servers, processing, memory, storage, applications, virtual machines, and services) that may be rapidly provisioned and released with minimal management effort or interaction with a provider of the service. This cloud model may include at least five characteristics, at least three service models, and at least four deployment models.

Using the on-demand self-service, a cloud consumer may unilaterally provision computing capabilities, such as server time and network storage, as needed automatically without requiring human interaction with the service's provider. Broad network access capabilities may be available over a network and accessed through standard mechanisms that promote use by heterogeneous thin or thick client platforms (e.g., mobile phones, laptops, and PDAs).

Resource pooling allows the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity capabilities may be rapidly and elastically provisioned, in some cases automatically, to quickly scale out and rapidly released to quickly scale in. To the consumer, the capabilities available for provisioning often appear to be unlimited and may be purchased in any quantity at any time. Measured service allows cloud systems automatically control and optimize resource use by leveraging a metering capability at some level of abstraction appropriate to the type of service (e.g., storage, processing, bandwidth, and active user accounts). Resource usage may be monitored, controlled, and reported providing transparency for both the provider and consumer of the utilized service.

Several service models are available, depending on implementation. Software as a Service (SaaS) provides the capability to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS) provides the capability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS) provides the capability to provision processing, storage, networks, and other fundamental computing resources where the consumer is able to deploy and run arbitrary software, which may include operating systems and applications. The consumer does not manage or control the underlying cloud infrastructure but has control over operating systems, storage, deployed applications, and possibly limited control of select networking components (e.g., host firewalls).

Several deployment models may be provided. A private cloud provides a cloud infrastructure that is operated solely for an organization. It may be managed by the organization or a third party and may exist on-premises or off-premises. A community cloud provides a cloud infrastructure that is shared by several organizations and supports a specific community that has shared concerns (e.g., mission, security requirements, policy, and compliance considerations). It may be managed by the organizations or a third party and may exist on-premises or off-premises.

A public cloud may provide a cloud infrastructure that is made available to the general public or a large industry group and is owned by an organization selling cloud services. A hybrid cloud provides a cloud infrastructure that is a composition of two or more clouds (private, community, or public) that remain unique entities but are bound together by standardized or proprietary technology that enables data and application portability (e.g., cloud bursting for load-balancing between clouds).

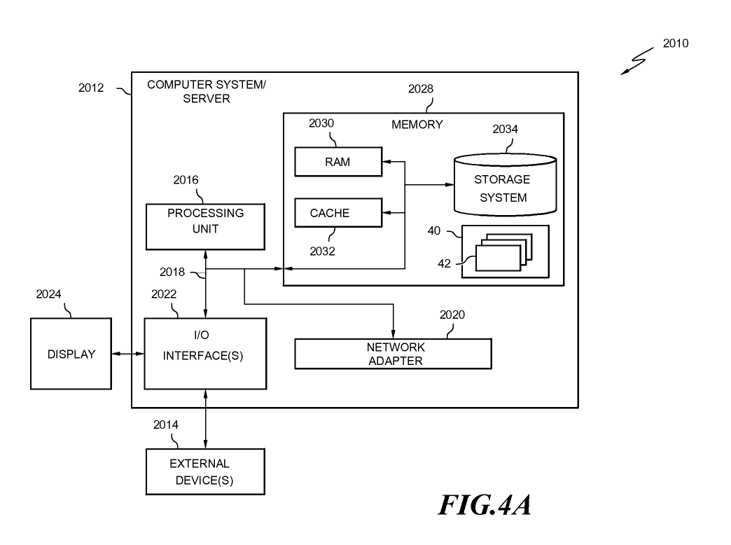

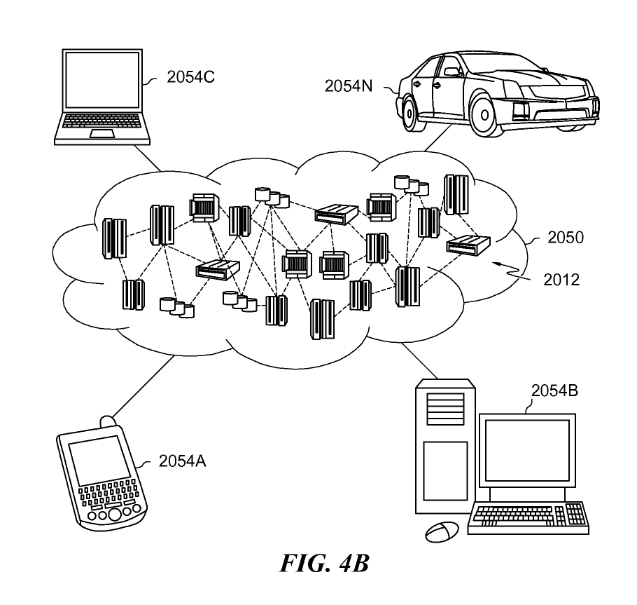

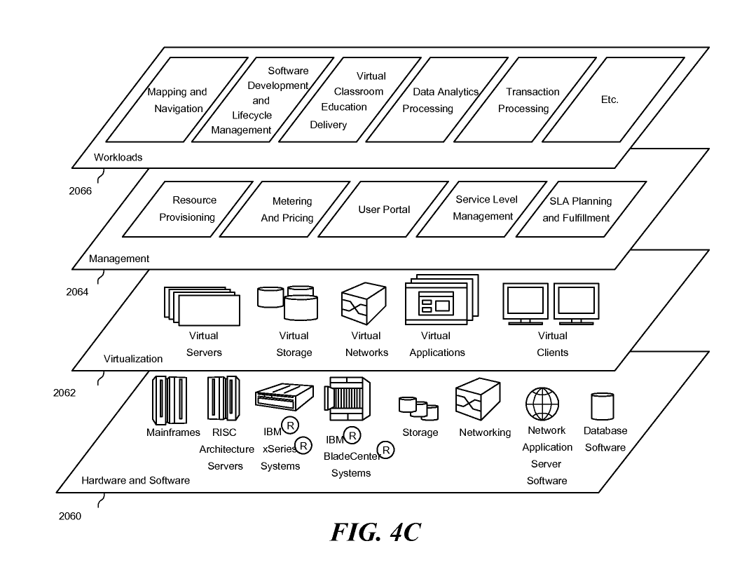

A cloud computing environment is service oriented with a focus on statelessness, low coupling, modularity, and semantic interoperability. At the heart of cloud computing is an infrastructure comprising a network of interconnected nodes. Referring now to FIG. 4A, a schematic of an example of a cloud computing node is shown. Cloud computing node 2010 is one example of a suitable cloud computing node and is not intended to suggest any limitation as to the scope of use or functionality of embodiments described herein. Regardless, cloud computing node 2010 is capable of being implemented and/or performing any of the functionality set forth hereinabove.

In cloud computing node 2010, there is a computer system/server 2012, which is operational with numerous other general purpose or special purpose computing system environments or configurations. Examples of well-known computing systems, environments, and/or configurations that may be suitable for use with computer system/server 2012 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 2012 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 2012 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4A, computer system/server 2012 in cloud computing node 2010 is shown in the form of a general-purpose computing device. The components of computer system/server 2012 may include, but are not limited to, one or more processors or processing units 2016, a system memory 2028, and a bus 2018 that couples various system components including system memory 2028 to processor 2016.

Bus 2018 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 2012 typically includes a variety of computer system readable media. Such media may be any available media that is accessible by computer system/server 2012, and it includes both volatile and non-volatile media, removable and non-removable media. System memory 2028 may include computer system readable media in the form of volatile memory, such as random access memory (RAM) 30 and/or cache memory 32.

Computer system/server 2012 may further include other removable/non-removable, volatile/non-volatile computer system storage media. By way of example, storage system 34 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided.

In some instances, the above components may be connected to bus 2018 by one or more data media interfaces. As will be further depicted and described below, memory 2028 may include at least one program product having a set (e.g., at least one) of program modules that are configured to carry out the functions of one or more embodiments.

Program/utility 2040, having a set (at least one) of program modules 42, may be stored in memory 2028 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of one or more embodiments.

Computer system/server 2012 may also communicate with one or more external devices 2014 such as a keyboard, a pointing device, a display 2024, etc.; one or more devices that enable a user to interact with computer system/server 2012; and/or any devices (e.g., network card, modem, etc.) that enable computer system/server 2012 to communicate with one or more other computing devices. Such communication may occur via I/O interfaces 2022. Still yet, computer system/server 2012 may communicate with one or more networks such as a local area network (LAN), a general wide area network (WAN), and/or a public network (e.g., the Internet) via network adapter 2020.

As depicted, network adapter 2020 communicates with the other components of computer system/server 2012 via bus 2018. It should be understood that although not shown, other hardware and/or software components could be used in conjunction with computer system/server 2012. Examples, include, but are not limited to: microcode, device drivers, redundant processing units, external disk drive arrays, RAID systems, tape drives, and data archival storage systems, etc.

Referring now to FIG. 4B, illustrative cloud computing environment 2050 is depicted. As shown, cloud computing environment 2050 comprises one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate.

Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device.

It is understood that the types of computing devices shown in FIG. 4B are intended to be illustrative only and that computing nodes 2010 and cloud computing environment 2050 may communicate with any type of computerized device over any type of network and/or network addressable connection (e.g., using a web browser).

Referring now to FIG. 4C, a set of functional abstraction layers provided by cloud computing environment 2050 (FIG. 4B) is shown. It should be understood in advance that the components, layers, and functions shown in FIG. 4C are intended to be illustrative of one or more embodiments and are not limited thereto. As depicted, the following layers and corresponding functions are provided.

Hardware and software layer 2060 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 2062 provides an abstraction layer from which the following examples of virtual entities may be provided: virtual servers; virtual storage; virtual networks, including virtual private networks; virtual applications and operating systems; and virtual clients. In one example, management layer 2064 may provide the functions described below. Resource provisioning provides dynamic procurement of computing resources and other resources that are utilized to perform tasks within the cloud computing environment.

Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met.

Service Level Agreement (SLA) planning and fulfillment provide pre-arrangement for, and procurement of, cloud computing resources for which a future requirement is anticipated in accordance with an SLA. Workloads layer 2066 provides examples of functionality for which the cloud computing environment may be utilized. Examples of workloads and functions which may be provided from this layer include: mapping and navigation; software development and lifecycle management; virtual classroom education delivery; data analytics processing; transaction processing; etc.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A machine implemented method for optimizing a virtualized communication network, the method comprising:
monitoring traffic among nodes in a virtualized communication network to determine one or more relationships among the nodes, wherein the nodes include physical and logically defined components;
determining whether one or more edges connecting the nodes in the communications network satisfy a rule;
grouping the nodes connected by the one or more edges that satisfy the rule into at least one group;
ranking the nodes in the group in accordance with a parameter; and
implementing a policy to optimize the virtualized communication network in accordance with information determined from the ranking or the grouping of the nodes.

2. The method of claim 1, wherein a first node and a second node are grouped in response to determining that level of traffic between the first node and the second node is beyond a threshold.

3. The method claim 1, wherein a first node and second node are grouped in response to determining that number of neighbor nodes that the first node and the second node have in common is beyond a threshold.

4. The method of claim 3, wherein neighbor nodes receive communication from the first node and the second node.

5. The method of claim 3, wherein neighbor nodes forward communication to the first node and the second node.

6. The method of claim 3, wherein neighbor nodes both receive and forward communication to the first node and the second node.

7. The method of claim 1, wherein a first node and a second node are grouped in response to determining that both the first node and the second node are connected by one or more edges that satisfy a relationship defined based on the aggregated amount of traffic communicated to the first node and the second node.

8. The method of claim 1, wherein a first node and the second node are grouped based on a calculated distance between the first node and the second node.

9. The method of claim 8, wherein the first node and the second node are grouped in response to determining that the distance between the first node and the second node is below a threshold.

10. The method of claim 9, wherein the number of neighboring nodes is determined by counting the number of nodes in between the first node and the second node, wherein the first node and the second node are connected by way of the neighboring nodes.

11. A system comprising one or more processors for optimizing a virtualized communication network, the system comprising:
a logic unit for monitoring traffic among nodes in a virtualized communication network to determine one or more relationships among the nodes, wherein the nodes include physical and logically defined components;
a logic unit for determining whether one or more edges connecting the nodes in the communications network satisfy a rule;
a logic unit for grouping the nodes connected by the one or more edges that satisfy the rule into at least one group;
a logic unit for ranking the nodes in the group in accordance with a parameter; and
a logic unit for implementing a policy to optimize the virtualized communication network in accordance with information determined from the ranking or the grouping of the nodes.

12. The system of claim 11, wherein a first node and a second node are grouped in response to determining that level of traffic between the first node and the second node is beyond a threshold.

13. The system claim 11, wherein a first node and second node are grouped in response to determining that number of neighbor nodes that the first node and the second node have in common is beyond a threshold.

14. The system of claim 13, wherein neighbor nodes receive communication from the first node and the second node.

15. The system of claim 13, wherein neighbor nodes forward communication to the first node and the second node.

16. A computer program product comprising a computer readable storage medium having a computer readable program, wherein the computer readable program when executed on a computer causes the computer to:
monitor traffic among nodes in a virtualized communication network to determine one or more relationships among the nodes, wherein the nodes include physical and logically defined components;
determine whether one or more edges connecting the nodes in the communications network satisfy a rule;
group the nodes connected by the one or more edges that satisfy the rule into at least one group;
rank the nodes in the group in accordance with a parameter; and
implement a policy to optimize the virtualized communication network in accordance with information determined from the ranking or the grouping of the nodes.

17. The computer program product of claim 16, wherein a first node and a second node are grouped in response to determining that level of traffic between the first node and the second node is beyond a threshold.

18. The computer program product of claim 16, wherein a first node and second node are grouped in response to determining that number of neighbor nodes that the first node and the second node have in common is beyond a threshold.

19. The computer program product of claim 18, wherein neighbor nodes receive communication from the first node and the second node.

20. The computer program product of claim 18, wherein neighbor nodes forward communication to the first node and the second node.
